(19) United States
(12) Patent Application Publication
(10) Pub. No.: US 2026/0055755 A1
(43) Pub. Date: Feb. 26, 2026

(54) ENERGY PRODUCTION APPARATUS

(71) Applicant: Dimitrios Kolios, North Bay (CA)

(72) Inventor: Dimitrios Kolios, North Bay (CA)

(21) Appl. No.: 19/325,205

(22) Filed: Sep. 10, 2025

Related U.S. Application Data
(63) Continuation of application No. 18/767,834, filed on Jul. 9, 2024, now abandoned.
Application No. 18/767,834 is a continuation of application No. 18/073,148, filed on Dec. 1, 2022, now abandoned.
Application No. 18/073,148 is a continuation of application No. 17/380,709, filed on Jul. 20, 2021, now abandoned.
(60) Provisional application No. 63/054,418, filed on Jul. 21, 2020.

(51) Int. Cl. F03D 3/04; F03D 3/00; F03D 3/06; F03D 9/25

(52) U.S. Cl. CPC F03D 3/0409; F03D 3/005; F03D 3/068; F03D 9/25

(57) ABSTRACT

The apparatus comprises: a cylinder having an opening presenting perpendicular to a flow of air in use such that, in use, air flows through the cylinder; and means for generating power based upon the flow of air through the cylinder.

### CROSS REFERENCE TO RELATED APPLICATION

This application is a Continuation of U.S. patent application Ser. No. 18/767,834 filed Jul. 9, 2024, which is a Continuation with and claims priority to U.S. patent application Ser. No. 18/073,148 filed Dec. 1, 2022, which is a Continuation with and claims priority to co-pending U.S. patent application Ser. No. 17/380,709 filed Jul. 20, 2021 which claims priority to United States Provisional Patent Application 63/054,418 filed Jul. 21, 2020, the disclosure of which is entirely incorporated by reference. The above identified applications are incorporated herein by reference in their entireties for all purposes.

### FIELD

The invention relates to devices, such as alternators, for generating power for use with moving vehicles.

### BACKGROUND

In the automotive field, it is ubiquitous for an alternator to be powered by the engine; the power from the alternator is used to charge the battery and power the electronics of the vehicle. However, alternators have significant drag.

### SUMMARY OF THE INVENTION

Forming one aspect of the invention is apparatus for use with a flow of air, the apparatus comprising:
a pair of cylinders, each having an axis and a pair of ends, the cylinder being disposed in use such that:
   one of the pair of ends is in the air flow and the other of the pair of ends is not; and
   the axis is disposed substantially perpendicular to the direction of air flow;
for each cylinder, a piston mounted in said each cylinder for axial reciprocating motion;
for each cylinder, a butterfly valve disposed adjacent the one of the pair of ends;
a linkage coupled to the pistons and the butterfly valves such that:
   as one of the pistons moves from the end in the air flow to the end not in the air flow, the other of the pistons moves from the end not in the air flow to the end in the air flow;
   each butterfly valve closes as the plunger reaches the end of the cylinder in the air flow and opens as the plunger reaches the end of the cylinder not in the air flow; and
a generator driven by the linkage to produce electricity.

Forming another aspect of the invention is apparatus for use with a flow of air, the apparatus comprising:
a cylinder having an opening presenting perpendicular to the flow of air such that, in use, air flows through the cylinder; and
means for generating power based upon the flow of air through the cylinder.

### BRIEF DESCRIPTION OF THE FIGURES

FIG. 1 shows apparatus according to one embodiment of the invention.

### DETAILED DESCRIPTION

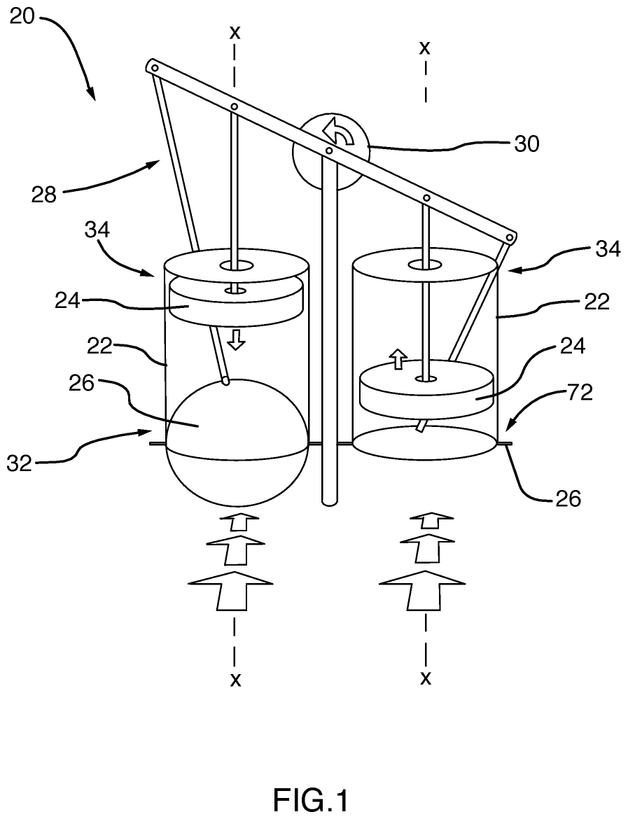

Apparatus 20 according to an embodiment of the invention is shown in FIG. 1 and will be seen to comprise a pair of cylinders 22, a pair of pistons 24, a pair of butterfly valves 26, a linkage 28 and a generator 30.

The cylinders 22 each have an axis X-X and a pair of ends 32,34.

The pistons 24 are provided one for each cylinder and mounted therein for axial reciprocating motion.

The butterfly valves 26 are provided one for each cylinder and are disposed adjacent one 32 of the pair of ends of said each cylinder.

The linkage 28 is coupled to the pistons and the butterfly valves such that:
as one of the pistons moves from the one 32 of the pair of ends to the other 34 of the pair of ends, the other of the pistons moves from the other of the pair of ends to the one of the pair of ends;
each butterfly valve closes as the plunger reaches the one 32 of the pair of ends and opens as the plunger reaches the other 34 of the pair of ends.

The generator 30 is adapted to be driven by the linkage 28 to produce electricity.

In use, the cylinders 22 are disposed in an air flow such that: the one of the pair of ends is in the air flow and the other of the pair of ends is not; and the axis is disposed substantially perpendicular to the direction of air flow.

This apparatus was exposed to a 55 mph air flow, indicated by the arrows, with the cylinders 22 disposed at approximately 70° to the air flow, and produced 2.64 watts of energy. The cylinders were 1.5 inches in diameter and 12 inches long and the pistons were each 3.3 oz.

Without intending to be bound by theory, inventor postulates that the pistons are urged into motion when in communication with atmosphere (via open butterfly valves) via the Bernoulli effect, and that the power available will vary with differential velocity, i.e. the speed of the fluid past the ends of the cylinders exposed in the stream.

Persons of ordinary skill in the art will readily appreciate that the apparatus has many uses. Apparatus of this type could, for example, be disposed on the undercarriage of a road vehicle, and used to charge a battery.

Other uses, as well as variations to the apparatus are possible. Accordingly, the invention should be understood to be limited only by the accompanying claims, purposively construed.

1. (canceled)

2. (canceled)

3. An apparatus for use with a flow of air having a direction, the apparatus comprising:
a pair of cylinders, each cylinder having an axis and a pair of ends spaced apart from one another along the axis, each cylinder being disposed in use such that:
only one end of the pair of ends is disposed in, or communicates with, the flow of air; and
the axis is disposed substantially perpendicular to the direction of the flow of air;
a piston mounted in each cylinder of the pair of cylinders for axial reciprocating motion;
a butterfly valve disposed in each cylinder adjacent the one end of its associated cylinder that communicates with the flow of air;
a linkage coupled to the pistons and the butterfly valves such that:
as one of the pistons moves in its associated cylinder from the cylinder end that is disposed in, or communicates with, the flow of air to the cylinder end not in the flow of air, the other of the pistons moves in its associated cylinder from the end not in the flow of air to the cylinder end in the flow of air;
said linkage further operative such that as each of the pistons moves in its associated cylinder from the end not in the flow of air to the cylinder end that is in the flow of air, the butterfly valve of its associated cylinder opens and such that as each of the pistons moves in its associated cylinder from the end in the flow of air to the end not in the flow of air, the butterfly valve of its associated cylinder closes; and
a generator coupled to the linkage, such that it is driven by the linkage and adapted to produce electricity when driven.

4. The apparatus of claim 3 wherein the cylinders are elongate and equally sized.

5. The apparatus of claim 3 wherein the pistons are annular in shape and equal in size.

6. The apparatus of claim 3 wherein the cylinders are disposed at approximately 70° to the direction of the flow of air and said pistons are urged into motion due to a Bernoulli effect.

7. A method for producing electricity from a flow of air having a direction, the method comprising:
providing a pair of cylinders, each cylinder having an associated axis and a pair of ends spaced apart from one another along the associated axis and positioning said cylinders such that:
only one end of the pair of ends of each cylinder communicates with the flow of air; and
positioning the axis of each cylinder so that each axis is substantially perpendicular to the direction of the flow of air;
providing a piston in each cylinder of the pair of cylinders, the associated piston mounted in its associated cylinder for axial reciprocating motion;
providing a butterfly valve for each cylinder of the pair of cylinders, said respective butterfly valve disposed adjacent the one of the pair of ends of its associated cylinder;
providing a linkage coupled to the pistons and the butterfly valves such that: as one of the pistons moves in its associated cylinder from the end that communicates with the flow of air to the end not in the flow of air, the other of the pistons moves in its associated cylinder from the end not in the flow of air to the end that communicates with the flow of air;
opening the butterfly valve of its associated cylinder as the associated piston moves in the associated cylinder from the end not in the flow of air to the end in the flow of air;
closing the butterfly valve of its associated cylinder as the associated piston moves in its associated cylinder from the end communicating with the flow of air to the end not in the flow of air; and providing an electrical generator operated by the linkage to produce electricity.

8. The method of claim 7 wherein the cylinders are elongate and equally sized.

9. The method of claim 7 wherein the pistons are annular in shape and equal in size.

10. The method of claim 7 further comprising a step of positioning the cylinders at approximately 70° to the direction of the flow of air such that said pistons are urged into motion due to a Bernoulli effect.

11. The method claim 7 further comprising a step of utilizing a Bernoulli effect to apply forces to said pistons to cause movement in said pistons.

12. An apparatus for transferring energy by use of air flow, the apparatus comprising:
first and second cylinders, each cylinder having an axis and a first and a second end spaced apart from one another by a cylinder wall along the axis;
first and second pistons mounted in first and second cylinders, respectively, the first and second cylinders for axial reciprocating motion of the first and second pistons within their respective cylinder;
first and second butterfly valves disposed in respective first and second cylinders adjacent said second end of its associated cylinder that communicates with air flow during operation;
a linkage that includes a support bar pivotally coupled to a support member, the support bar having first and second valve rods and first and second piston rods, wherein each valve rod is rotatably coupled to said support bar at a first end of the valve rod and is rotatably coupled at a second end of the valve rod to each butterfly valve, and further wherein each piston rod is rotatably coupled to said support bar at a first end of each piston rod and is rotatably coupled at a second end of each piston rod to each piston;
said linkage, first and second piston rods, and said first and second valve rods being spaced about said support member such that:
said first and second piston when reciprocated to said first end of said respective cylinder, said respective first and second butterfly valve is reciprocated to an open position such that said respective cylinder is open to atmosphere; and
said first and second piston when reciprocated to said second end of said respective cylinder, said respective first and second butterfly valve is reciprocated to a closed position such that said respective cylinder is closed to atmosphere.

13. The apparatus of claim 12 further comprising a generator coupled to the linkage, such that it is driven by the linkage and adapted to produce electricity when driven.

14. The apparatus of claim 12 further comprising an air source for directing air flow transversely to said axis of said first and second cylinders and at said second end of said first and second cylinders during operation.

15. The apparatus of claim 12 wherein said first and second piston rods are substantially symmetrically spaced on said support bar about said support member such that when said first piston is translated by said first piston rod to said first end within said first cylinder, said second piston is translated by said second piston to said second end within said second cylinder.

16. The apparatus of claim 12 wherein said first piston rod and first valve rod are spaced about said support bar on a first side of said support member such that when said first piston is translated by said first piston rod to said first end within said first cylinder, said first butterfly valve is rotated by said first valve rod to an open atmospheric position at said second end of said first cylinder, and said first piston rod and first valve rod are spaced about said support bar on said first side of said support member such that when said first piston is translated by said first piston rod to said second end within said first cylinder, said first butterfly valve is rotated by said first valve rod to a closed to atmospheric position at said second end of said first cylinder.

17. The apparatus of claim 13 further comprising an air source for directing air flow at said second end of said first and second cylinders during operation.

18. The apparatus of claim 17 wherein said first and second piston rods are substantially symmetrically spaced on said support bar about said support member such that when said first piston is translated by said first piston rod to said first end within said first cylinder, said second piston is translated by said second piston to said second end within said second cylinder.

19. The apparatus of claim 18 wherein said first piston rod and first valve rod are spaced about said support bar on a first side of said support member such that when said first piston is translated by said first piston rod to said first end within said first cylinder, said first butterfly valve is rotated by said first valve rod to an open atmospheric position at said second end of said first cylinder, and said first piston rod and first valve rod are spaced about said support bar on said first side of said support member such that when said first piston is translated by said first piston rod to said second end within said first cylinder, said first butterfly valve is rotated by said first valve rod to a closed to atmospheric position at said second end of said first cylinder.

20. The apparatus of claim 14 wherein said first and second piston rods are substantially symmetrically spaced on said support bar about said support member such that when said first piston is translated by said first piston rod to said first end within said first cylinder, said second piston is translated by said second piston to said second end within said second cylinder.

21. The apparatus of claim 14 wherein said first piston rod and first valve rod are spaced about said support bar on a first side of said support member such that when said first piston is translated by said first piston rod to said first end within said first cylinder, said first butterfly valve is rotated by said first valve rod to an open atmospheric position at said second end of said first cylinder, and said first piston rod and first valve rod are spaced about said support bar on said first side of said support member such that when said first piston is translated by said first piston rod to said second end within said first cylinder, said first butterfly valve is rotated by said first valve rod to a closed to atmospheric position at said second end of said first cylinder.
